(19) United States
(12) Patent Application Publication
(10) Pub. No.: US 2026/0071585 A1
(43) Pub. Date: Mar. 12, 2026

(54) DIAGNOSTIC METHOD AND DIAGNOSTIC DEVICE FOR GAS FLOW CONTROL VALVE OF INTERNAL COMBUSTION ENGINE

(71) Applicant: NISSAN MOTOR CO., LTD., Yokohama-shi (JP)

(72) Inventor: Naoki MATSUDA, Kanagawa (JP)

(21) Appl. No.: 19/323,747

(22) Filed: Sep. 9, 2025

(30) Foreign Application Priority Data
Sep. 11, 2024 (JP) 2024-157200

(51) Int. Cl. F02D 41/22; F02D 41/00; F16K 37/00

(52) U.S. Cl. CPC F02D 41/22; F02D 41/0002; F16K 37/0083; F02D 2200/70

(57) ABSTRACT

A TCV function diagnosis and rationality diagnosis are repeatedly performed during normal operation, and the CSERS diagnosis is performed with the condition that the engine is in a cold state. The time required for the TCV function diagnosis is approximately the same as that for the rationality diagnosis, and each of the diagnoses is completed at time t3. The time required for the CSERS diagnosis set to be shorter such that the completion of the CSERS diagnosis is before the completion of the TCV function diagnosis and rationality diagnosis, and the CSERS diagnosis is completed at time t2.

### BACKGROUND

The present invention relates to fault diagnosis of a gas flow control valve disposed on the upstream side of an intake port for variably controlling gas flow within a cylinder.

For example, in internal combustion engines mounted on vehicles, as is well known, fault diagnosis of actuators, sensors, or control circuits, as target diagnoses, that constitute various control systems is required by law in various countries for the purpose of ensuring safety and exhaust performance.

Japanese Patent Application Publication No. 2009-150326 (hereinafter is simply referred to as a “patent document 1”) discloses that fault diagnosis for a gas flow control valve (for example, a tumble control valve), as a diagnostic target, disposed on the upstream side of an intake port for variably controlling gas flow within a cylinder is performed.

However, in current internal combustion engines, a plurality of diagnoses with different primary purposes or low to be followed may be performed in parallel for a single device, such as a gas flow control valve, raising concerns about potential competition. For example, when a gas flow control valve is determined to be abnormal by one diagnosis, and a valve opening degree of the gas flow control valve is fixed due to a fail-safe control associated with the abnormal determination, other diagnoses being performed in parallel may fail to complete.

### SUMMARY

The present invention is a method for diagnosing a gas flow control valve of an internal combustion engine, wherein the gas flow control valve is disposed on an upstream side of an intake port for variably controlling gas flow within a cylinder, the method comprising: comparing a target opening degree as a control target with an actual opening degree of the gas flow control valve that is detected by a sensor, during an operation of the internal combustion engine, wherein the diagnosis comprises: a first diagnosis performed regardless of whether the internal combustion engine is in a warm-up state or cold state, and performed to command a fail-safe control including fixing of an opening degree of the gas flow control valve when an abnormality is determined; and a second diagnosis for which completion is required by law, and that is performed under the cold state, and wherein a diagnostic processing time and a diagnosis start timing for each of the first and second diagnoses are set such that the completion of the second diagnosis is before completion of the first diagnosis, when the first diagnosis and the second diagnosis are performed in parallel under the cold state.

In this way, when the first diagnosis and the second diagnosis are performed in parallel while the engine is in a cold state, the second diagnosis is always completed first. Therefore, when there is an abnormality in the control system of the gas flow control valve, diagnosis completion required by law can be satisfied without competing with the fail-safe control (fixing of the opening degree of the gas flow control valve) associated with the abnormality determination by the first diagnosis.

According to the present invention, it is possible to surely avoid a phenomenon in which the second diagnosis performed in a cold state competes with the first diagnosis and prevents the completion of the diagnosis required by law.

### BRIEF DESCRIPTION OF THE DRAWINGS

FIG. 1 is an explanatory diagram schematically showing the system configuration of an internal combustion engine according to the present invention.

FIG. 2 is a time chart showing the operation of a tumble control valve diagnosis in a cold state.

FIG. 3 is a time chart showing the operation in a comparative embodiment.

### DETAILED DESCRIPTION

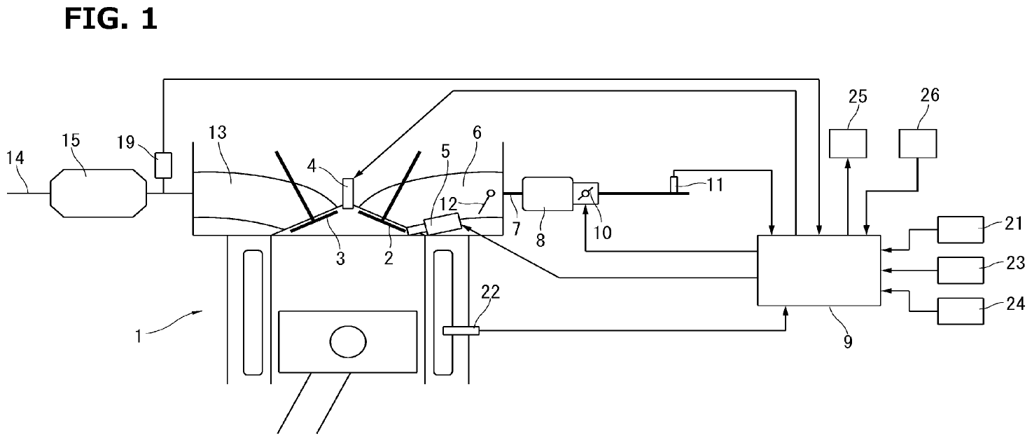

In the following, one embodiment of the present invention will be explained in detail with reference to the drawings. FIG. 1 is an explanatory diagram showing a schematic configuration of an internal combustion engine 1 in one embodiment to which the present invention is applied. Although the internal combustion engine 1 is, for example, an internal combustion engine used as a travel driving source for a vehicle, it may also be an internal combustion engine used for power generation in a series hybrid vehicle. The internal combustion engine 1 in one embodiment is a spark-ignition internal combustion engine (so-called gasoline engine) with a four-stroke cycle, and is equipped with an intake valve 2, an exhaust valve 3, and an ignition plug 4 for each cylinder. In addition, as a cylinder direct-injection type internal combustion engine, a fuel injection valve 5 that injects fuel into a cylinder is disposed at an appropriate position in the cylinder. Fuel is supplied to the fuel injection valve 5 at a predetermined fuel pressure adjusted by a pressure regulator (not shown), and when the fuel injection valve 5 opens in response to a drive pulse signal from an engine controller 9, an amount of fuel corresponding to the pulse width is injected.

An electronically controlled throttle valve 10, whose opening degree is controlled by a control signal from the engine controller 9, is disposed on the upstream side of a collector portion 8 of an intake passage 7 connected to an intake port 6 of each cylinder. An airflow meter 11 for detecting the intake air amount is disposed on the upstream side of the throttle valve 10, and an air cleaner (not shown) is disposed on the further upstream side.

Here, a tumble control valve 12 is provided as a gas flow control valve at the inlet portion of the intake port 6 in each cylinder, so as to cover, for example, the lower half of the passage cross-section. The tumble control valve 12 is configured to rotate about a rotation axis along a cylinder row direction and the opening degree of the tumble control valve 12 is controlled via an actuator 25 controlled by a control signal from the engine controller 9. In addition, the actual opening degree of the tumble control valve 12 is detected by a position sensor 26. For example, in one embodiment, the actuator 25 is connected to one end of a rotation shaft common to a plurality of cylinders, and the position sensor 26 is connected to the other end. In a state in which the tumble control valve 12 is closed, the intake air flowing into a cylinder through the intake valve 2 flows rapidly in a state of deflecting to one side, thereby increasing the strength of the tumble flow within the cylinder. The tumble control valve 12 in one embodiment has a so-called normally closed type, and in a state in which the actuator 25 is not driven by the engine controller 9, it is in the closed position as illustrated. In addition, the opening degree of the tumble control valve 12 in one embodiment is stepwisely controlled in multiple stages.

Exhaust ports 13 of respective cylinders are collected into a single exhaust passage 14, and a three-way catalyst 15 for exhaust purification is provided in the exhaust passage 14. For example, the three-way catalyst 15 is a so-called monolithic ceramic catalyst in which a catalyst layer containing a catalyst metal is coated on the surface of a monolithic ceramic body formed with fine passages. In addition, the three-way catalyst 15 may also have a configuration including a plurality of catalysts (for example, a manifold catalyst and an underfloor catalyst) arranged in series.

An air-fuel ratio sensor 19 for detecting the exhaust air-fuel ratio is disposed at the inlet side of the three-way catalyst 15 of the exhaust passage 14, namely, on the upstream side of the three-way catalyst 15.

The detection signals from the air-fuel ratio sensor 19, the air flow meter 11, and the position sensor 26 are input to the engine controller 9. The engine controller 9 further receives detection signals from various sensors, including a crank angle sensor 21 for detecting engine rotation speed, a water temperature sensor 22 for detecting cooling water temperature, an outside air temperature sensor 23 for detecting the outside air temperature, and an accelerator opening degree sensor 24 for detecting the amount of depression of the accelerator pedal operated by the driver. The engine controller 9 optimally controls the fuel injection amount and injection timing by the fuel injection valve 5, the ignition timing by the ignition plug 4, the opening degree of the throttle valve 10, the opening degree of the tumble control valve 12, and the like, based on these input signals.

The engine controller 9 performs a fault diagnosis of the tumble control valve 12 as one of the various controls of the internal combustion engine 1. Fault or abnormality of the tumble control valve 12 may include abnormality of the actuator 25, abnormality of the position sensor 26, or software-related abnormality of the control system. In the following, the diagnosis of the tumble control valve 12 that is the main part of the present invention will be explained.

There are three types of diagnoses for the tumble control valve 12 as a diagnostic target. The first is a TCV function diagnosis that is performed to confirm that the entire control system of the tumble control valve 12 is operated normally. The TCV function diagnosis is reset when the target opening degree of the tumble control valve 12 changes based on an operating condition and is performed while the target opening degree is stable. In other words, the diagnosis starts immediately after the target opening degree of the tumble control valve 12 changes, and it is completed if the target opening degree does not change during the time required for the diagnosis. When the target opening degree changes before the diagnosis is completed, the diagnosis is reset, and the next diagnosis starts immediately. The TCV function diagnosis compares the target opening degree set by the engine controller 9 based on an operating condition of the internal combustion engine 1 with the actual opening degree detected by the position sensor 26, and when the two are different, it is determined that there is an abnormality.

Then, when an abnormality is determined in the TCV function diagnosis, a predetermined fail-safe control command is output to suppress combustion deterioration caused by the abnormality of the tumble control valve 12. The predetermined fail-safe control performed by the engine controller 9 includes driving restrictions such as vehicle speed and output, a combustion restriction based on the assumption of tumble flow, and fixing of the tumble control valve 12. When the tumble control valve 12 is fixed, the driving of the actuator 25 is stopped, and unless the valve body is fixed, the tumble control valve 12 is in the fully closed position. The TCV function diagnosis is performed even when the target opening degree is intermediate, in addition to fully closing or fully open. In other words, regardless of whether the engine is in a warm-up state or cold state, the TCV function diagnosis is repeatedly performed during the operation of the internal combustion engine 1.

The second is a rationality diagnosis that is performed to mainly detect an abnormality in the position sensor 26. Similar to the TCV function diagnosis, the rationality diagnosis is reset when the target opening degree of the tumble control valve 12 changes based on an operating condition, and is performed while the target opening degree is stable. In other words, the diagnosis starts immediately after the target opening degree of the tumble control valve 12 changes, and it is completed if the target opening degree does not change during the time required for the diagnosis. When the target opening degree changes before the diagnosis is completed, the diagnosis is reset, and the next diagnosis starts immediately. However, unlike the TCV function diagnosis, the rationality diagnosis is performed only when the target opening degree is fully closing or fully open. The diagnostic technique is the same as that for the TCV function diagnosis. The engine controller 9 compares the target opening degree (fully closing or fully open) set based on an operating condition of the internal combustion engine 1 with the actual opening degree detected by the position sensor 26, and when the two are different, it is determined that there is an abnormality.

Then, when an abnormality is detected in the rationality diagnosis, a predetermined fail-safe control command is output to suppress combustion deterioration caused by the abnormality of the tumble control valve 12. The fail-safe control associated with the abnormality detection by the rationality diagnosis includes fixing of the tumble control valve 12. When the tumble control valve 12 is fixed, the actuator 25 stops driving, and unless the valve body is fixed, the tumble control valve 12 is in the fully closed position. The rationality diagnosis is repeatedly performed during the operation of the internal combustion engine 1, regardless of whether the engine is in a warm-up state or cold state, under the condition that the target opening degree is fully closing or fully open.

The above TCV function diagnosis and rationality diagnosis correspond to the “first diagnosis”in the claims.

The third is a CSEAR diagnosis that corresponds to the “second diagnosis” in the claims. This CSEAR diagnosis is performed to confirm that there is no abnormality in variable devices or control systems that affect the warm-up performance (namely, exhaust purification performance) of the three-way catalyst 15 after cold start. It is required by law to perform the diagnosis of the tumble control valve 12 as one of the variable devices, when the internal combustion engine 1 is in a cold state. Furthermore, the correct completion of the diagnosis is required by law.

Similar to the TCV function diagnosis and rationality diagnosis, the CSERS diagnosis is reset when the target opening degree of the tumble control valve 12 changes based on an operating condition, and is performed while the target opening degree is stable. In other words, the diagnosis starts immediately after the target opening degree of the tumble control valve 12 changes, and it is completed if the target opening degree does not change during the time required for the diagnosis. When the target opening degree changes before the diagnosis is completed, the diagnosis is reset, and the next diagnosis starts immediately. In addition, the CSERS diagnosis is performed only when the internal combustion engine 1 is in a cold state. The diagnosis technique is the same as that of the TCV function diagnosis, and the engine controller 9 compares the target opening degree (including the intermediate opening degree) set based on the operating condition of the internal combustion engine 1 with the actual opening degree detected by the position sensor 26, and when the two are different, it is determined that there is an abnormality. In the CSEERS diagnosis, when the tumble control valve 12 is determined to be abnormal, although the abnormality determination is recorded as a fault code, no active fail-safe control is performed.

The CSEERS diagnosis is performed only while the internal combustion engine 1 is in a cold state, as described above. In one embodiment, the CSERS diagnosis is performed in the cold state when the following three conditions are simultaneously satisfied: the soak time from the previous engine stop is equal to or longer than a predetermined time, the outside air temperature is higher than a predetermined temperature (set below freezing point), and the difference between the cooling water temperature and the outside air temperature is less than a predetermined temperature difference. Therefore, for example, after a cold start, the CSERS diagnosis is repeatedly performed in parallel with the TCV function diagnosis and the rationality diagnosis until the difference between the cooling water temperature and the outside air temperature reaches the predetermined temperature difference.

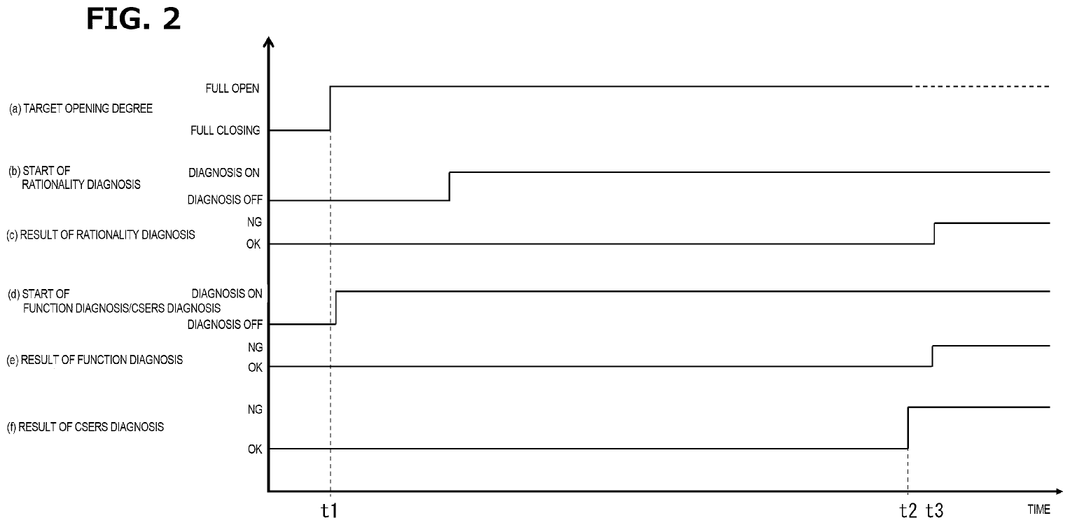

Next, referring to the time chart in FIG. 2, the required time for the three diagnoses when the internal combustion engine 1 is in a cold state is explained. The time chart in FIG. 2 shows (a) the target opening degree of the tumble control valve 12, (b) the start of the rationality diagnosis, (c) the result of the rationality diagnosis, (d) the start of the TCV function diagnosis and the CSERS diagnosis, (e) the result of the TCV function diagnosis, and (f) the result of the CSERS diagnosis. In the embodiment shown in FIG. 2, at time t1, the target opening degree changes from fully closing to fully open due to a change in the operating condition of the internal combustion engine 1. In response to the change in the target opening degree, the TCV function diagnosis and the CSERS diagnosis start substantially simultaneously immediately after time t1. The rationality diagnosis requires a predetermined time for the diagnosis permission determination, resulting in a diagnosis start timing that is delayed relative to the diagnosis start timing of the TCV function diagnosis and CSERS diagnosis.

The required time for each diagnosis (the time from when the target opening degree changes at time t1 until the diagnosis result (NG/OK) is obtained) is the sum of the time from the time t1 until the diagnosis start timing (referred to as a “diagnosis permission time”) and the time from the diagnosis start timing until the diagnosis result is obtained (namely, diagnosis completion) (referred to as the “diagnosis processing time”). In the present embodiment, when the three diagnoses are performed in parallel, the diagnostic permission time and diagnostic processing time for each diagnosis are set such that the completion of the CSEAR diagnosis is always before the completion of the TCV function diagnosis and the rationality diagnosis.

As described above, the diagnostic permission time for the TCV function diagnosis and the CSERS diagnosis is extremely short, for example, a microsecond, which corresponds to the program's processing cycle. The diagnostic processing time required for the arithmetic processing of the TCV function diagnosis, for explanatory purposes, is set to 5000 ms. Therefore, the total time required for the TCV function diagnosis is approximately 5000 ms. In contrast, the diagnostic permission time for the rationality diagnosis is relatively long, for example, 1000 ms. The diagnostic processing time required for the arithmetic processing of the rationality diagnosis is set, for example, to 4000 ms. Therefore, the required time for the rationality diagnosis is approximately equal to the required time for the TCV function diagnosis and is 5000 ms.

In contrast, the diagnostic processing time required for the arithmetic processing of the CSEAR diagnosis is set to 4,700 ms, which is 300 ms shorter than the diagnostic processing time for the TCV function diagnosis, to allow for appropriate leeway at the timing of diagnostic completion.

Therefore, the CSERS diagnosis is completed at time t2 in FIG. 2, and the TCV function diagnosis and rationality diagnosis are completed at time t3, which is later than time t2.

Here, in the embodiment shown in FIG. 2, there is an abnormality in the tumble control valve 12, and at time t2, the CSERS diagnosis results in an NG judgment, and at time t3, the TCV function diagnosis and rationality diagnosis each result in an NG judgment.

In this way, by setting the diagnostic permission time and diagnostic processing time for each diagnosis such that the completion of the CSERS diagnosis always precedes the completion of the TCV function diagnosis and rationality diagnosis, the CSERS diagnostic is always completed correctly.

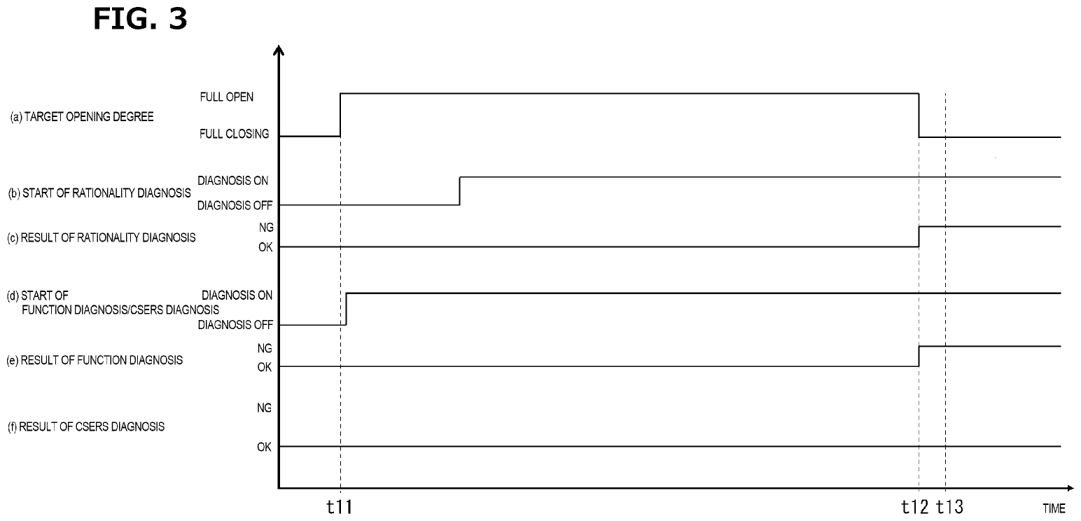

FIG. 3 shows a time chart as a comparative embodiment in which the TCV function diagnosis or rationality diagnosis is completed before the CSERS diagnosis. In this comparative embodiment, although the target opening degree changes from fully closing to fully open at time t11, it is assumed that there is an abnormality in the tumble control valve 12 and the position sensor 26 detects the fully closed position. Therefore, when the rationality diagnosis is completed at time t12, an NG judgment is made. Due to this NG judgment, fail-safe control is performed, and the target opening degree is set to be fully closing to stop the driving of the tumble control valve 12. As a result, a state in which the target opening degree and the actual opening degree (detected opening degree) match appears, and in the CSERS diagnosis that completes with a delay at time t13, it may not be possible to correctly determine an NG judgment.

As the above, although one embodiment of the present invention has been explained in detail, the present invention is not limited to the above embodiment and various changes might be made to the embodiment without departing from the scope and spirit of the present invention. The present invention includes equivalents thereof.

For example, the tumble control valve as a diagnosis target is not limited to the configuration shown in the drawings and may have any configuration. In addition, the gas flow control valve may be a swirl control valve. Furthermore, in the above embodiment, although diagnosis that is performed when the target opening degree is fully open has been explained, the same applies to diagnosis at an intermediate opening degree.

The entire contents of Japanese Patent Application 2024-157200 filed Sep. 11, 2024 is incorporated herein by reference.

1. A method for diagnosing a gas flow control valve of an internal combustion engine, wherein the gas flow control valve is disposed on an upstream side of an intake port for variably controlling gas flow within a cylinder, the method comprising:
comparing a target opening degree as a control target with an actual opening degree of the gas flow control valve that is detected by a sensor, during an operation of the internal combustion engine,
wherein the diagnosis comprises:
a first diagnosis performed regardless of whether the internal combustion engine is in a warm-up state or cold state, and performed to command a fail-safe control including fixing of an opening degree of the gas flow control valve when an abnormality is determined; and
a second diagnosis for which completion is required by law, and that is performed under the cold state, and
wherein a diagnostic processing time and a diagnosis start timing for each of the first and second diagnoses are set such that the completion of the second diagnosis is before completion of the first diagnosis, when the first diagnosis and the second diagnosis are performed in parallel under the cold state.

2. The method for diagnosing the gas flow control valve of the internal combustion engine according to claim 1,
wherein the first diagnosis comprises:
a diagnosis performed to confirm that an entire control system of the gas flow control valve is operated normally; and
a diagnosis performed to detect an abnormality in the sensor under a predetermined target opening degree, and
wherein the diagnosis for the confirmation and the diagnosis for the detection are performed in parallel.

3. The method for diagnosing the gas flow control valve of the internal combustion engine according to claim 1,
wherein, in the second diagnosis, the fixing of the opening degree of the gas flow control valve is not performed when the abnormality is determined.

4. The method for diagnosing the gas flow control valve of the internal combustion engine according to claim 1,
wherein the second diagnosis is performed in the cold state when three conditions are simultaneously satisfied: a soak time from a previous engine stop is equal to or longer than a predetermined time, an outside air temperature is higher than a predetermined temperature set below freezing point, and a difference between a cooling water temperature and the outside air temperature is less than a predetermined temperature difference.

5. The method for diagnosing the gas flow control valve of the internal combustion engine according to claim 1,
wherein, as the gas flow control valve, a tumble control valve is to be diagnosed.

6. A device for diagnosing a gas flow control valve of an internal combustion engine, wherein the gas flow control valve is disposed on an upstream side of an intake port for variably controlling gas flow within a cylinder, the device comprising:
an engine controller configured to perform the diagnosis by comparing a target opening degree as a control target with an actual opening degree of the gas flow control valve that is detected by a sensor, during an operation of the internal combustion engine,
wherein the diagnosis comprises:
a first diagnosis performed regardless of whether the internal combustion engine is in a warm-up state or cold state, and performed to command a fail-safe control including fixing of an opening degree of the gas flow control valve when an abnormality is determined; and
a second diagnosis for which completion is required by law, and that is performed under the cold state, and
wherein a diagnostic processing time and a diagnosis start timing for each of the first and second diagnoses are set such that the completion of the second diagnosis is before completion of the first diagnosis, when the first diagnosis and the second diagnosis are performed in parallel under the cold state.
